(19) United States
(12) Patent Application Publication
(10) Pub. No.: US 2006/0242706 A1
(43) Pub. Date: Oct. 26, 2006

(54) Methods and systems for evaluating and generating anomaly detectors

(76) Inventor: Robert B. Ross, Arlington, VA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/368,114

(22) Filed: Mar. 3, 2006

Related U.S. Application Data
(60) Provisional application No. 60/660,931, filed on Mar. 11, 2005.

(51) Int. Cl. G06F 12/14

(52) U.S. Cl. 726/23

(57) ABSTRACT

Methods, systems, and processor readable medium for selecting an anomaly detector for a system, including: generating an anomaly detector (AD) candidate population by characterizing AD candidates by one or more system parameters and system attributes (collectively herein, “system attributes”); training the AD candidate population using non-anomaly data associated with the system and the system attribute(s); evaluating the AD candidate population based on applying non-anomaly and anomaly data associated with the system to the AD candidate population; and, based on at least one search criterion, performing at least one of (i) selecting an AD candidate from the AD population; and, (ii) modifying the AD candidate population and iteratively returning to training the AD candidate population.

### CLAIM OF PRIORITY

This application claims priority to U.S. Ser. No. 60/660,931, filed on 11 Mar. 2005, naming Robert B. Ross as inventor, the contents of which are herein incorporated by reference in their entirety.

### BACKGROUND

(1) Field

The disclosed methods and systems relate generally to anomaly detection, and more particularly to methods and systems for evaluating, designing, and/or generating anomaly detectors.

(2) Description of Relevant Art

Anomaly detection (“AD”) systems have broad applicability in a wide variety of systems. With the recent proliferation of computer network viruses and other network disturbances that can cause network slowdowns and/or interruptions, and hence translate to increased costs for businesses and others, AD systems can be applied to network systems in an attempt to identify network disturbances and reduce damage therefrom.

Historically, intrusion detection systems (IDS) have been used for the network intrusion issue. In contrast to AD systems, in some IDS systems, network activity is compared to a database of attack signatures in an attempt to identify a specific attack that has already been documented; however, such systems are limited by the extent of the database and the extent to which the attacks in the database have been characterized. Although the foregoing IDS configuration methodology, by attempting to maximize the known or a priori information, can be effective for documented intrusions, such methodologies can be less effective when presented with a network attack having a new and/or varied signature.

Generally, in AD systems, a system manager or another defines a baseline or “normal” state of the network by characterizing the network based on, for example, protocols, packet sizes, network loads, and other network characteristics. A typical AD system may inspect incoming and outgoing network communications and attempt to identify patterns indicative of an intrusion by a system “hacker”, virus, or other undesired source, by comparing network characteristics to the normal/baseline characteristics. Based on detection and/or suspicion of an intrusion or other undesirable activity, ADs can be configured to provide alerts, isolate the network by blocking traffic, re-program a firewall, log-off users, and/or take other actions.

### SUMMARY

The present teachings relate to methods, systems, and processor-readable media for selecting an anomaly detector for a system, including: generating an anomaly detector (AD) candidate population by characterizing AD candidates by one or more system attributes or parameters (collectively referred to herein as “system attributes”); training the AD candidate population using non-anomaly data associated with the system and the system attribute(s); evaluating the AD candidate population based on applying non-anomaly and anomaly data associated with the system to the AD candidate population; and, based on at least one search criterion, performing at least one of: (i) selecting an AD candidate from the AD population; and, (ii) modifying the AD candidate population and iteratively returning to training the AD candidate population.

The evaluating can be based on determining at least one performance metric for the AD candidates in the AD candidate population. The performance metric(s) can be, for example, a utility function based on a probability of false positives and/or a probability of false negatives. In embodiments, a performance metric can include a Geometric mean, a weighted precision, and/or a harmonic mean scheme. Accordingly, for the present teachings, selecting an AD candidate from the population can include comparing performance metrics associated with AD candidates, and identifying an AD candidate based on the comparison.

In an embodiment of the present teachings, modifying the AD candidate population can be based on evaluating the AD candidate population. For example, modifying the AD candidate population can be based on a genetic algorithm(s). In some of such embodiments, an objective or other scheme can be used to identify a relative best fit AD candidate, whereupon the AD candidate population can be adjusted using genetic techniques such as mutation, crossover, inherency, etc. In some embodiments, the AD candidate population can be modified based on sequential modification using a constraint associated with one or more system attributes. For example, an AD candidate population can be modified to “optimize” one system attribute before attempting to “optimize” another system attribute. As provided herein, “optimization” is relative to selected techniques, criteria, etc., and thus an “optimum” solution for one embodiment may be different for another embodiment. In embodiments, the AD candidate population can be modified based on one or more unsupervised learning schemes, where in some instances, such schemes may allow for more than one “normal” state (e.g., as compared to an “anomaly” state).

In some embodiments, modifying the AD candidate population can include adding one or more system attributes to at least part of the AD candidate population, and/or eliminating one or more system attributes from at least part of the AD candidate population.

As provided herein, the methods, systems, and processor-readable media allow for one or more search criterion that can include a number of iterations, a time interval, and/or satisfaction of at least one performance criterion. The search criterion can thus be based on a search scheme which, as previously provided, can include genetic and/or evolutionary programming, simulated annealing, and others.

Generally, the AD candidate (system) attribute(s) can be associated with one or more (system) attribute parameter(s), and accordingly, training the AD candidate population can include processing system attribute data based on the associated attribute parameter(s). For example, the attribute parameter(s) may be associated with temporal alignment of data associated with system attribute data, mathematically transforming data associated with system attribute data, filtering data associated with system attribute data, partitioning data associated with system attribute data, and/or quantizing data associated with system attribute data.

Training the AD candidate population can include determining one or more summary statistics for each system attribute, where the summary statistic(s) can be associated with a distance metric. The distance metric can allow for a determination and/or classification of a “normal” state versus an “anomaly” state. Accordingly, evaluating the AD candidate population can include using at least one summary statistic to determine a probability of anomaly for a system attribute(s), where the summary statistic is associated with a distance metric. In some embodiments, evaluating an AD candidate population includes, for a specified AD candidate and a specified time period, computing an overall probability of anomaly based on combining a probability of anomaly for each system attribute. The combining of the probability of anomaly for each system attribute can be based on a distance metric. The evaluating can also include comparing a (overall) probability of anomaly to a probability threshold.

In some embodiments of the present teachings, evaluating the AD candidate population can include penalizing an AD candidate based on the number of system attributes associated therewith. For example, an AD candidate can be penalized for having fewer than a specified number (or number range), or more than a number (or number range), of system attributes.

Other objects and advantages will become apparent hereinafter in view of the specification and drawings.

### BRIEF DESCRIPTION OF THE DRAWINGS

FIG. 1 is an example Supervisory Control and Data Acquisition (SCADA) system to which the present teachings can be applied;

FIG. 2A is a block diagram showing one embodiment of the present methods and systems;

FIG. 2B is another block diagram showing further features of some aspects of the present methods and systems;

FIG. 3 demonstrates one example of selecting an AD configuration;

FIG. 4 illustrates one example of generating summary statistics for a selected AD configuration;

FIG. 5 provides one example for evaluating a selected AD configuration; and,

FIG. 6 is a block diagram showing another embodiment of the present methods and systems.

### DESCRIPTION

To provide an overall understanding of the present teachings, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the present teachings. Additionally, the shapes and sizes of components are also exemplary and unless otherwise specified, can be altered without affecting the scope of the exemplary systems or methods of the present teachings.

The present teachings relate to methods and systems for designing Anomaly Detection (“AD”) systems and methods, including processor-readable media, where such AD system and method designs can be achieved through iterative techniques that include generating a population of AD candidates by characterizing and/or representing such AD candidates based on one or more system attributes or system parameters (collectively referred to herein as “system attributes”) for which the AD system is to be applied. The present teachings also can include associating none, some, or all of the system attributes with system attribute parameters (referred to herein more succinctly as “attribute parameters”) that may allow for processing and/or combining of the system attribute data. Once the system attribute data is collected and processed, the AD candidates can be trained using “normal” system data that is associated with the system attributes, whereupon the AD candidate performance can be evaluated using normal and anomaly data and a distance metric that can allow for a determination of at least a normal and an abnormal state. Based on performance of one or more AD candidates, a further search can be performed by modifying the AD candidate population based on a search scheme, and there can be an iterative repeating of the foregoing until an AD candidate is selected and/or identified based on, for example, search criteria and/or performance criteria. The present teachings thus allow for a comparison of different AD systems that may be configured in different manners. Although the illustrated embodiments may relate to AD systems as applied to computer and/or other communications networks, it can be understood that the AD systems and methods of the present teachings have wide applicability and relate to other applications of AD systems and methods. Such other applications may include, but are not limited to, for example, Supervisory Control and Data Acquisition (SCADA) systems (e.g., electricity, gas, oil, water, manufacturing, product testing, etc.), control systems, sensor systems, and others.

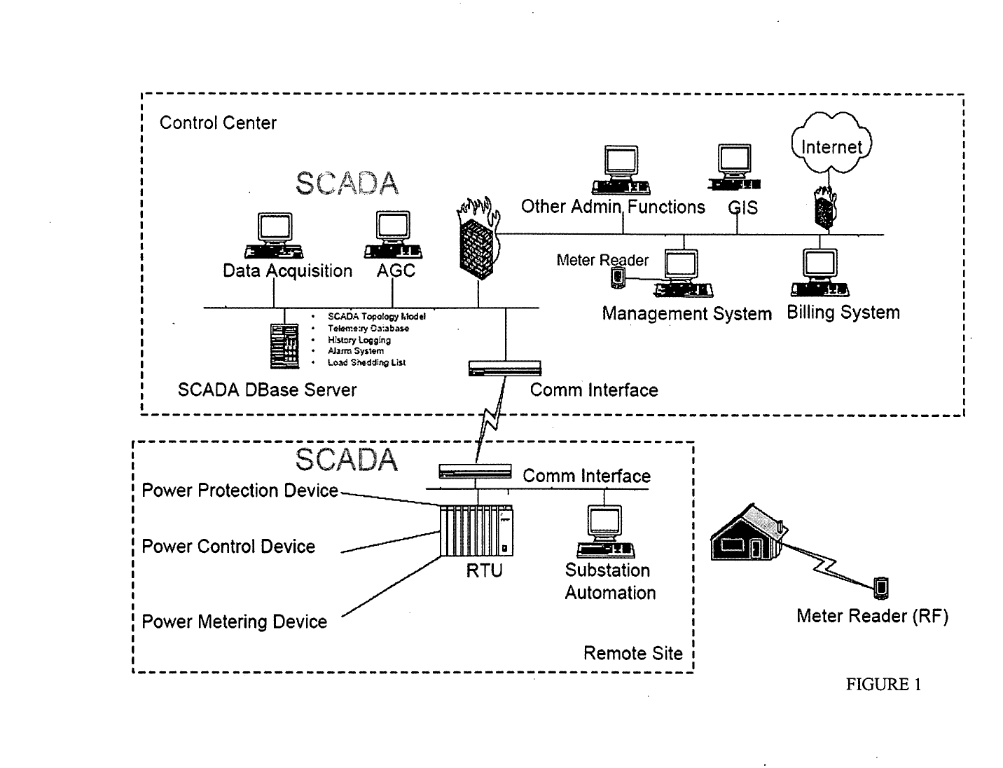

FIG. 1 shows a Supervisory Control and Data Acquisition (SCADA) system which is one type of network system to which the present teachings can be applied. SCADA systems are typically employed to monitor and/or control conditions, facilities, sensors, etc., that generally are at a remote location, where data from such remote location is transferred to a control center to allow for data analysis, data presentation, etc., and the provision of alerts when needed to signal an anomaly condition. Accordingly, like other types other networked systems, a SCADA system can be vulnerable to intrusions and/or network “attacks” that can compromise the integrity of the network and the data thereon.

The illustrated SCADA system of FIG. 1 shows a remote site having a remote terminal unit (RTU) that can be connected through various wired and/or wireless communications links to one or more monitoring and/or other devices such as a power protection device, a power control device, and/or a power metering device, with such examples provided for illustration and not limitation. As FIG. 1 illustrates, the RTU can further communicate, for example, via one or more communications interfaces, to the illustrated control center that may contain one or more databases for collecting data from the remote site, analyzing the data, providing control back to the remote site, and/or providing alerts. The control center can also include a data acquisition device and automatic generation control (AGC) (e.g., feedback control system to regulate the power output of electric generators to maintain a specified system frequency and/or scheduled interchange), that can be connected, via a firewall, for example, to a billing system, a management system, a geographic information system (GIS), and other systems. Because SCADA systems are often used to provide real-time assessment of critical aspects of a system and/or location, SCADA systems can be viewed as desirable targets for attacks because such attacks can cause substantial financial and/or other losses.

As provided herein, the present teachings can allow for the determination of an anomaly detection (“AD”) system that can detect aberrations and/or intrusions into a system such as systems according to FIG. 1, to reduce the likelihood of compromising the integrity of such a system. Such AD systems, once designed, may be implemented in hardware and/or software, and may reside at one or more locations throughout the networked system; however, it can be understood for the illustrated embodiment that the AD system design, selection and/or implementation may reside at a control center for a system according to FIG. 1.

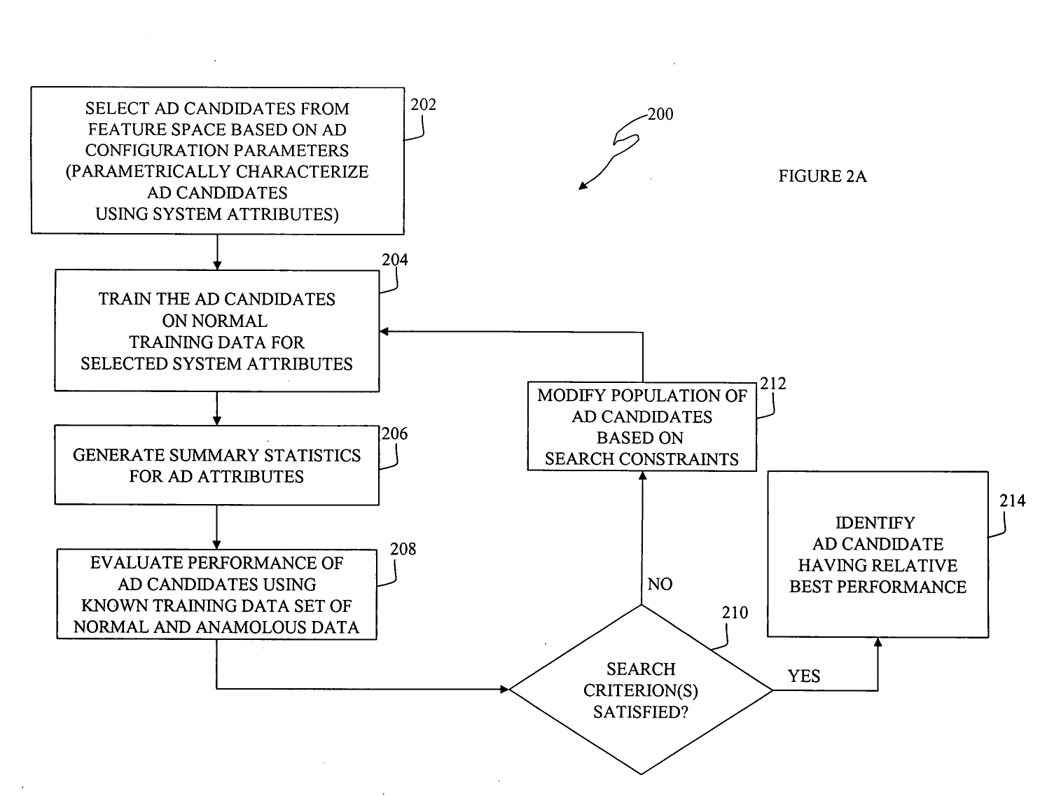

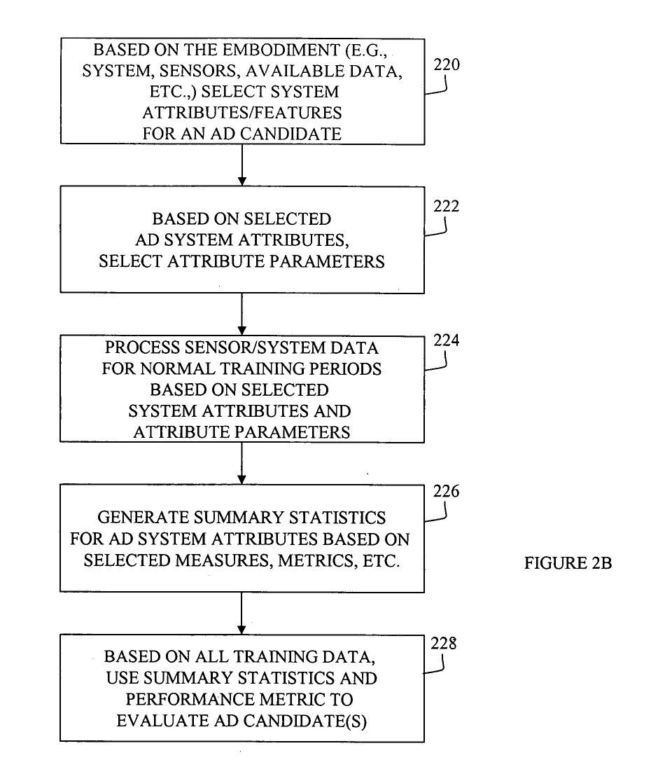

FIG. 2A provides a block diagram 200 of systems and methods according to some embodiments of the present teachings for evaluating and/or generating AD systems and methods. As indicated in FIG. 2A, AD system candidates can be selected 202, manually or automatically, in series or in parallel, from a feature space that allows for variable numbers of data types (e.g., TCP packets, BSM system calls, etc.), feature vector sizes, distance metrics, computation times, performance measures, and other features, as will be described herein. Accordingly, a user (human or non-human) of the present methods and systems can generate and/or select one or more AD system candidates from the AD candidate feature space 202 (defined by system attributes) by representing and/or characterizing such AD candidates by associating such candidates with system attributes, and in embodiments, further associating such AD system attributes with attribute parameters that may, in some instances, further characterize the system attributes. The system attributes that represent and/or characterize the AD candidate(s) may be based on the embodiment to which the AD will be applied (e.g. based on the system features, the types of data to represent the system, etc.), and thus, for example, in an embodiment that includes a processor, an AD candidate may be characterized and/or represented by a feature vector that includes AD system attributes for CPU usage and jitter, amongst others, and parameters related to such system attributes. In embodiments, an attribute parameter associated with an AD candidate system attribute(s) may correspond to feature selection and may describe how AD system attributes/features are selected, which may include, for example, specifying a system attribute/feature selection methodology or scheme for selecting attributes/features, or a designation of attributes/features. Another attribute parameter may include how data associated with system attributes are processed, and may include attribute parameters such as filtering schemes (e.g., retain N most recent data points, remove M % of outliers) and/or filtering parameters, and can include filter specification (e.g., Weiner, Hamming, Hanning, Gaussian, etc.), filter period, filter weights, etc., that may be applied to the data that corresponds to the specified attributes. Another attribute parameter may include specifying a manner in which system attribute data may be partitioned, for example, Euclidean, Gaussian, etc. In embodiments, system attribute data may be quantized, and thus quantization (attribute) parameters can be specified such as providing a fixed number of data “buckets”, a fixed data bucket range, maximum size of buckets, merging similar buckets, allowing adjacent buckets to balance error versus computation time, etc. Further, AD candidate attributes may be associated with summarization parameters that may allow a group of data corresponding to an attribute to be summarized as one (or more) data point for inclusion in a feature vector, where such summarization parameters can include mean, median, distance, probability threshold, curve fitting, entropy, number of inflections, etc. The system attribute data can be applied to curve fitting techniques that may include Gaussian, wavelets, order N polynomial, etc. Parameters for system attribute data can relate to data partitioning such as X-axis and Y-axis. In embodiments, the attribute data may be augmented, for example, by overlaying white noise at a given level, pink noise at a given level, etc.

Because the methods and systems taught herein have wide applicability to, for example, SCADA and other systems where system attribute data (such as CPU usage and jitter) may be asynchronously available to the methods and systems taught herein, the present methods and systems can include a synchronization (attribute) parameter for allowing system attribute data from different sensors and sources, and/or data associated with different system attributes, for example, to be temporally aligned to a particular time point or time range/period such that different system attribute members of a feature vector can be associated with a particular time point/period, and thus synchronization parameters may include interpolation, extrapolation, smoothing schemes, etc., and parameters (e.g., weights, etc.) associated therewith. In embodiments, system attributes can be associated with transformation parameters that may determine whether attribute data is transformed using some mathematical or other processing scheme such as taking a derivative, taking a logarithm, squaring, etc. It can thus be understood and will be shown herein that the present teachings are extendable to systems which have different types of system attribute data (e.g., float, double, integer, Boolean, etc.).

Attribute parameters may also include summary statistics (e.g., mean, median, maximum, etc.) that may assist in determining whether a particular system attribute is classified as normal or anomaly in a certain time period. Summary statistics may thus be related to, associated with, and/or derived from a distance metric attribute that can allow for the determination of a normal state from an anomaly state for a given system attribute and/or set of system attributes. As will be provided herein, based on a designation and/or selection of a distance metric, summary statistics can be determined and/or computed to facilitate a classification of normal versus anomaly. Accordingly, distance metric parameters can be related to clustering schemes for the attributes to determine distance from normal, and can include Euclidean distance, Gaussian (e.g., area under the curve), Extrema (e.g., minimum, maximum), etc.

Attribute parameters can thus be related to system attributes or feature selection, feature computation and/or processing, and feature assessment and/or classification. It can thus be understood that the selection of system attributes, and the associated selection of attribute parameters, is based on the embodiment and is not limited to the particular system attributes or attribute parameters described specifically herein.

As a further illustration, in some embodiments of the present teachings where the system includes at least one processor, for example, system attributes may be categorized as process attributes (e.g., thread count, working set, processor time, operations per second, etc.), memory attributes (e.g., memory usage, page faults per second, system code resident bytes, etc.), system-type attributes (e.g., exception dispatches per second, system calls per second, etc.), network attributes (e.g., ratio of bytes sent and received per second, current bandwidth, etc.), server attributes (e.g., files open, percent disk time, directory searches, etc.), for example, although such examples are provided for illustration and not limitation. As provided herein, such system attributes can be further associated with attribute parameters which might characterize such attributes in terms of type, measure, and/or performance. As provided herein, for example, attribute parameters might describe how to aggregate and/or summarize system attribute data over a data collection period. Such attribute parameters may include parameters related to clustering (e.g., for unsupervised learning schemes), feature selection (e.g., branch and bound schemes), filtering of the system attribute data (e.g., noise filters and outlier removal schemes), partitioning of the system attribute data (e.g., cycle identification schemes), quantization parameters (e.g., histogram compression schemes), summarization parameters (e.g., measures of central tendency and curve fitting schemes), synchronization parameters (e.g., baseline correction schemes), transformation parameters (e.g., derivatives, logs, unit interval scaling, z-scores, exponential, square root, etc.), distance parameters (e.g., Euclidian, Interquartile range, Mahalanobis, Minkowski, Chebyshev, Kolmogorov, Matusita, Canberra, Kullback-Liebler, Jeffrey, Topsoe, Bhattacharyya, Chernoff, ResistorAvg, Pearson, Bedard, etc.), statistical parameters/tests (e.g., ANOVA, Chi-Squared, Gaussian, Student's t, Spearman rho, etc.), etc. It can thus be understood that the attribute parameters associated with a given system attribute or set of system attributes may vary based on the embodiment, and that different embodiments may use different system attributes.

For the present methods and systems, because “anomaly” can be different based on different attacks, the signature of which is not always known a priori, as provided herein, a metric for determining normal from anomaly may include distance from normal. As can be understood by one of ordinary skill, the selected system attributes for the respective AD candidates can allow for different representations of “normal” based on the selected feature space. Further, the selected system attributes can allow for a determination of distance from “normal”, e.g., the attribute data, when processed and applied to the distance metric, and combined with a selected probability threshold, can allow for a classification of the data as “normal” or “anomaly”, thereby allowing for an estimation of a probability of anomaly and the evaluation of the AD candidate based on the AD candidate features (e.g., system attributes).

Referring again to FIG. 2A, once the AD candidates are represented 202 by system attributes, the AD candidates can be trained based on normal periods of training data 204 associated with the system attributes. As such, based on the AD candidate attributes and attribute parameters, feature vectors can be correspondingly formed for each AD candidate using the normal periods of the training data. The training 204 can be based on different constraints imposed by a user of the methods and systems of the present teachings. Once trained, based on a selected distance metric, respective summary statistics for the different system attributes of the AD candidates can be generated 206.

With continued reference to FIG. 2A, typical/“normal” and atypical/“anomaly” system data can be applied to the AD candidates and the ADs evaluated 208 based on their classification of the known training data conditions using the summary statistics generated with relation to the distance metric, as at 206. In further accordance with the distance metric, data across different system attributes can be combined to allow for an evaluation of AD candidate performance 208 with respect to actual system data “labels” (e.g., known to be “normal”, known to be “anomaly”) to allow for a computation of a performance metric. In embodiments, a performance metric may be based on a user-selected probability threshold associated with the AD candidate, and may further associated with a weight of false positives (wfp), a weight of false negatives (wfn), a probability of false positive (pfp), and a probability of false negative (pfn). In some embodiments, this performance metric can be understood to be an objective function such as known in genetic/evolutionary programming.

As may be understood to one of ordinary skill in the art, a user (human or non-human) of the present methods and systems, such as a system administrator or another, may be allowed to select a search scheme in accordance with the present teachings. For example, search schemes might include exhaustive searches, genetic/evolution searches, optimizing one randomly selected system attribute at a time (“random focus”), etc. Based on the search scheme selection, other search parameters may be selected (e.g., number of generations, time limits, etc.). Search schemes may optionally and/or additionally relate to satisfying a performance criterion.

Referring again to FIG. 2A, if a respective search criterion(s) is not satisfied 210, the AD candidate population may be modified 212 in accordance with the search scheme (e.g., mutation, crossover, etc. for genetic/evolutionary searches; select another AD candidate for exhaustive searches, etc.) before being retrained 204 and the process iterating as shown by the looping back to training 204 illustrated in FIG. 2A for method 200. In some embodiments, only the AD candidate with the relative “best” performance (e.g., as indicated by the performance metric and/or performance criterion(s)) may be retained for modification and generation of a new set of AD candidates, while in some embodiments, such AD candidate may be the only candidate that is not modified. It can be understood that a new “set” of AD candidates may differ in as little as one AD candidate from another AD candidate set. It can also be understood that the modification 212 of the population of AD candidates can be performed in a variety of ways, and can be based on various constraints and/or configuration parameters and/or search schemes. For example, if the modification 212 is performed using a genetic/evolutionary technique, constraints can be related to inherency, mutation, crossover, and other genetic/evolutionary constraints. Based on a search scheme that is used to modify the population at 212, some embodiments may include search constraints related to population size, time limit (e.g., maximum number of seconds before terminating/cutoff), turnover, number of refinements, number of generations, allowable stalls (e.g., maximum number of stalls before terminating/cutoff), utility improvement needed to avoid a stall, probability of mutation for a given AD system attribute, probability of producing a mutated child, etc. In some embodiments, the modification 212 can be performed using simulated annealing techniques, while in other embodiments, by “optimizing” one system attribute at a time (e.g., randomly selected or non-randomly selected), and other ways.

For the purposes of the present teachings, “optimizing” can be understood to be relative optimization based on system constraints, the user's selections, etc., and accordingly, “optimizing” for one embodiment may be different from “optimizing” for another embodiment. Further, a sequential optimizing of different AD attributes may be performed in a variety of system attribute orders.

As indicated in FIG. 2A, such iterating of the modifying 212 and training 204, etc., can continue until an AD candidate is identified and/or selected which has the relative best performance metric upon satisfying a search criterion, as shown at 214.

FIG. 2B shows another view of the present methods and systems where a set of system attributes are selected 220 for one or more AD candidates. As provided herein, such system attributes are selected 220 based on the system under potential attack, the perceived threat to the system, the available data (e.g., sensors, etc.), etc. Attribute parameters are also selected 222 to characterize the different system attributes. Training can then be performed 224 by processing data from the normal periods associated with the system attribute data, for example, or other training constraints that may be specified (e.g., removing useless system attributes from consideration). Summary statistics may be generated 226 for each remaining system attribute based on the processed data. Using the summary statistics and a performance measure (e.g., distance measure and probability threshold), a performance metric for the AD candidate(s) can be determined (e.g., utility function, etc.) and the AD candidate(s) evaluated 228. The process shown in FIG. 2B can thus be performed for multiple AD candidates, in series or in parallel, before such are evaluated per FIG. 2A as to whether a search criterion(s) is satisfied.

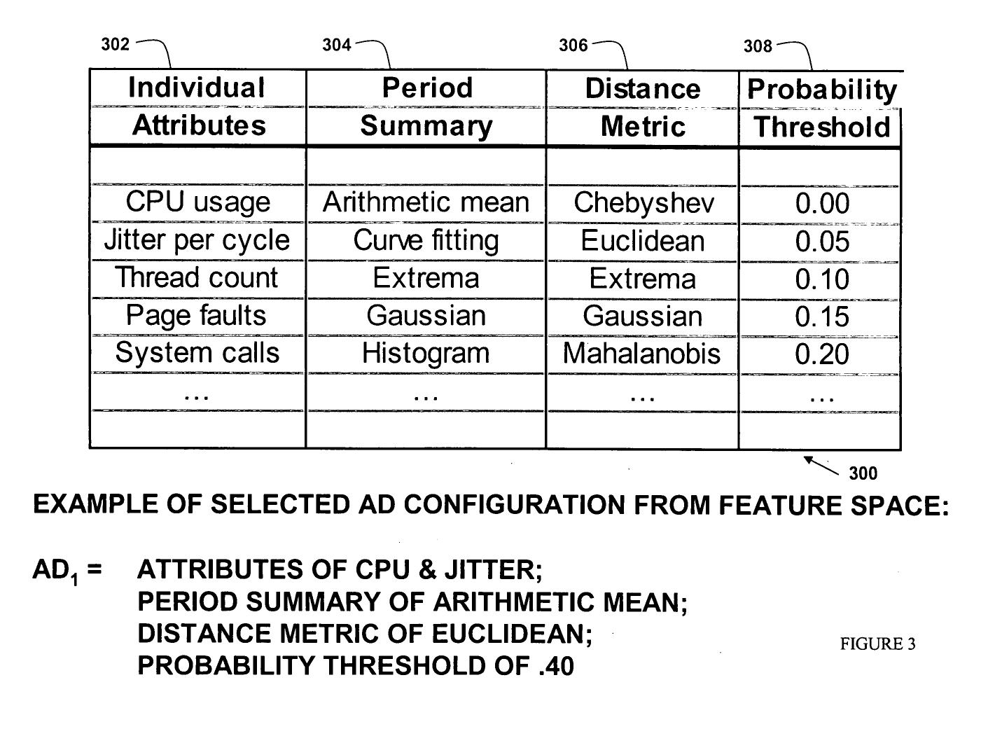

FIG. 3 shows one example of a simplified search space 300 for AD candidates where individual system attributes in the FIG. 3 example include CPU usage, jitter per cycle, thread count, page faults, system calls, and others. As provided herein, the data for systems to which the present teachings may be applied may be asynchronous and of different type and variation, and thus a “Period Summary” statistic 304 may be selected to coordinate and/or summarize data from different sensors to allow for a temporal alignment (e.g., to a particular time range). In the FIG. 3 example, such “Period Summary” statistics for the foregoing FIG. 3 system attributes may include arithmetic mean, curve fitting, Extrema (e.g., maximum, minimum), Gaussian, Histogram, and others, while available distance metrics for the FIG. 3 embodiment include Chebyshev (e.g., based on the supremum norm), Euclidean, Extrema, Gaussian (e.g., based on area under the Gaussian distribution), Mahalanobis, and others. As shown in FIG. 3, the search space can allow for “Probability Thresholds” that can range anywhere from 0.00 to 1.00, and although the FIG. 3 embodiment allows for selections in increments of 0.05, such example is provided for illustration and not limitation. As provided herein, combinations of such system attributes 302, period summary statistics 304, distance metrics 306, and probability thresholds 308 can be used to generate different AD candidates. It can thus be understood that the present methods and systems can have a multitude of implementations that can include, for example, a graphical user interface (GUI) that may allow a user, system administrator, etc., of such GUI(s) to select and/or specify different AD candidates using mechanisms such as drop-down menus, etc., where such may further be combined with automated schemes to allow for complete or partial automation of the present teachings. Referring again to FIG. 3, FIG. 3 indicates an example AD candidate (“Example: AD₁”) that is selected using system attributes of CPU usage and jitter per cycle, with arithmetic mean as a Period Summary (attribute) statistic or parameter, Euclidean distance as a distance measure or metric, and 0.4 as a probability threshold.

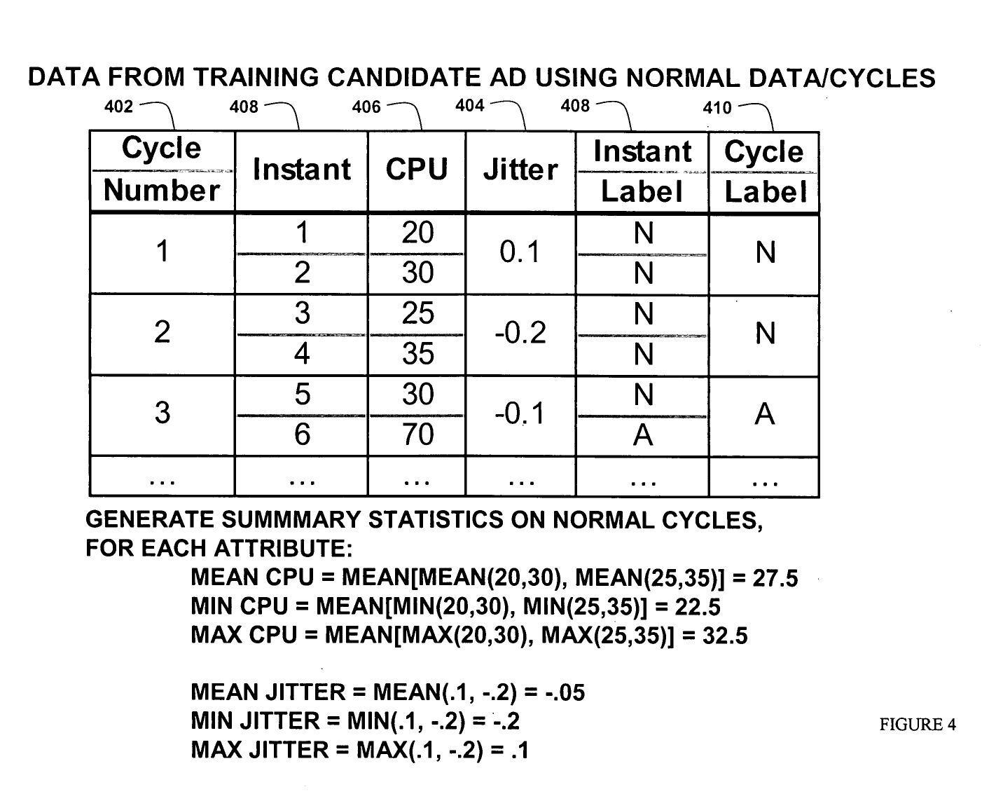

FIG. 4 illustrates an example of generating summary statistics for the exemplary system AD₁ of FIG. 3. As FIG. 4 indicates, in the time or cycle 402 between consecutive jitter measurements 404, there are generally two CPU measurements 406, or instants 408. Further, as FIG. 4 indicates, there are two cycles (e.g., cycles one and two) that are “normal” (N), while cycle three is anomalous (A), and thus only cycles one and two will be used during training for summary statistic generation.

For the illustrated embodiment, as one of ordinary skill in the art will understand, the selections of “arithmetic mean” for period summary parameter and “Euclidean” for distance metric imply intermediate computations which are also shown in FIG. 4. As FIG. 4 shows, for both system attributes of CPU usage and jitter, the selection of “arithmetic mean” not only implies a computation of such mean over all normal cycles/training data, but also, because such computation is to be related to a probability threshold, also implied is a computation of the extrema of minimum and maximum to allow for a scaling of the mean value to a range between the probability limits of zero and one. Accordingly, as FIG. 4 indicates, the CPU usage arithmetic mean (for “normal” cycles one and two) is computed by first computing the means for each cycle (“cycle means”), and then computing the mean of the “cycle means”. The extrema (minimum and maximum) are similarly computed for CPU usage. As FIG. 4 also illustrates, because jitter per cycle includes only one measurement per jitter cycle, the mean is the average of the jitter for cycles one and 2 (e.g., (0.1+−0.2)/2) while the minimum and maximum of jitter are similarly computed.

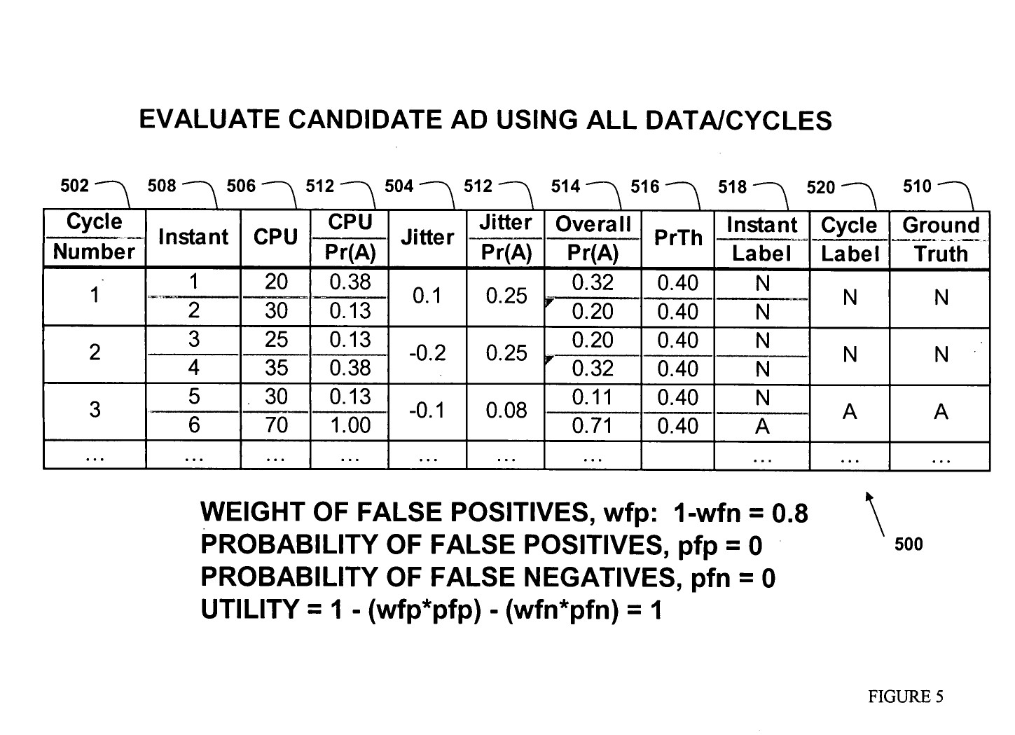

FIG. 5 illustrates an example of evaluating a selected candidate AD. FIG. 5 provides further data 500 where the candidate AD is evaluated using the entire training set, which in the illustrated instance, includes three cycles 502 of data with jitter 504 in which six CPU usage measurements 506 are made in six instants 508. From FIG. 5, the “ground truth” 510 for the first two cycles is “normal” or N, while the ground truth is “anomaly” or A for the third cycle.

As previously provided herein, the selected “distance metric” for the illustrated AD candidate is the “Euclidean” measure, and as one of ordinary skill in the art will understand, such selection implies a series of intermediate computations. Referring to FIG. 5, the present teachings allow for an intermediate probability of anomaly (Pr(A)) 512 for the different system attributes, which are then combined to provide an overall probability of anomaly. For the illustrated AD candidate, for each “instant” 508 of FIG. 5, a probability of anomaly 512 can be computed for each system attribute according to Equation 1:
ABS[(Measurement−Mean)]/[(Maximum−Minimum)*ScaleFactor], (1)
where ABS indicates absolute value. It can be understood by those of ordinary skill that Equation 1 anticipates a Euclidean distance measure from the selected “Arithmetic Mean” by obtaining the distance of a system attribute measurement from the computed arithmetic mean for that system attribute over normal cycles; however, this distance is scaled by the computed attribute range (e.g., maximum less minimum) for that system attribute over normal cycles to allow for a value within the selected probability threshold limits of zero and one. As one of ordinary skill in the art will also understand, because the computed system attribute ranges are computed on a finite set of normal training data, such computed system attribute ranges are likely not representative of the entire range of “normal” values for a given system attribute, and accordingly, the ScaleFactor can further allow a user or another to further scale the range to allow for “normal” values outside the computed range based on the finite data set. ScaleFactor is thus a variable component.

Upon computation of a Pr(A) 512 for each system attribute at each FIG. 5 “instant” 508 in accordance with Equation 1, such Pr(A) 512 for each system attribute can be combined according to the selected Euclidean distance metric to allow for an overall probability of anomaly (“Overall Pr(A)”) 514, which for the example of FIG. 5 can be computed for each “instant” 508 in accordance with Equation (2):
Overall Pr(A)=SQRT[SUM(AttributeᵢPr(A))²]/SQRT[i] (2)
where according to Equation 2, and in accordance with the selected Euclidean measure, the square root of the sum of the squares Pr(A) for all i system attributes is obtained and scaled by the square root of the number of the system attributes to provide a measure between zero and one.

For example, taking instant three of FIG. 5, the following computations are performed:

In accordance with Equation 1, using a ScaleFactor of 2:
CPU Pr(A)=ABS[(25−27.5)]/[(32.5−22.5)*2]=0.125
Jitter Pr(A)=ABS[−=0.2−(−0.5)]/[(0.1−(−0.2))*2]0.25

In accordance with Equation 2:

$$\begin{matrix}Overall Pr ( A ) = SQRT [ {( CPU Pr ( A ) )}^{2} + {( Jitter Pr ( A ) )}^{2} ] / SQRT ( 2 ) \\ = SQRT [ {( .125 )}^{2} + {( .25 )}^{2} ] / SQRT ( 2 ) \\ = .1976\end{matrix}$$

Although in this example computation of an overall Pr(A) 514, the ScaleFactor for all system attributes was the same, it can be understood that such in other embodiments, different system attributes may have a different ScaleFactor. Those of ordinary skill will recognize that when extremely anomalous values are evaluated, the formulas above may produce a value for Pr(A) that exceeds one, and thus, in general, the probability of anomaly is understood to be the min(1, Pr(A)).

Referring again to FIG. 5, once an overall Pr(A) 514 is computed for a given FIG. 5 “instant” 508, such overall Pr(A) 514 can be compared to the selected or designated probability threshold, PrTh 516, selected in this instance (e.g., FIG. 3) to be 0.40. As also shown in FIG. 5, based on a comparison of the computed overall Pr(A) 514 to the PrTh 516, each instant can be labeled as “normal”/“N”, or “abnormal”/“A”. For the illustrated example, if any instant within a cycle has a label 518 of “A”, the entire cycle is provided with a label 520 of “A”, although it can be understood that in other embodiments, for example, for an entire cycle to be labeled “A”, a specified number and/or percentage of instants, for example, may be required to have an “A” label. Other variations can be understood by those of ordinary skill in the art.

As FIG. 5 also indicates, the performance metric upon which the example AD candidate is measured is a “utility” metric which is based upon the probability of false positives, probability of false negatives, and their associated weights. In the FIG. 5 example, a weight of false negatives is arbitrarily selected as 0.2, thereby making the weight of false positives 0.8. Probabilities of false positives (pfp) and false negatives (pfn) can be computed by comparing the “Ground Truths” 510 to “Cycle Labels” 520, which for the three cycles of FIG. 5, provide a pfp and a pfn which are each zero due to the perfect alignment of cycle labels with ground truths. The utility metric of this AD candidate, as shown in FIG. 5, is thus one, or perfect. With reference to FIG. 2A, for example, a probability of false positives and/or negatives, or optionally, a utility metric such as that provided by this example AD candidate, may be a reason for stopping the search (e.g., at 210) and identifying this AD candidate as the “best” relative performer 214, which in the present instance, is the AD candidate having the lowest magnitude pfp and/or pfn (or optionally, the greatest magnitude utility metric). In contrast, with continued reference to FIG. 2, had the pfp of this example been, for example, 0.3, with a search “stop criterion” 210 of 0.15, the search could have continued 212 by perhaps modifying this AD candidate (and/or presumably others, based on the search scheme) to generate a new set of AD candidates for evaluation (it being understood that other search “stop” criterion must also be considered, such as, for example, number of iterations, etc.).

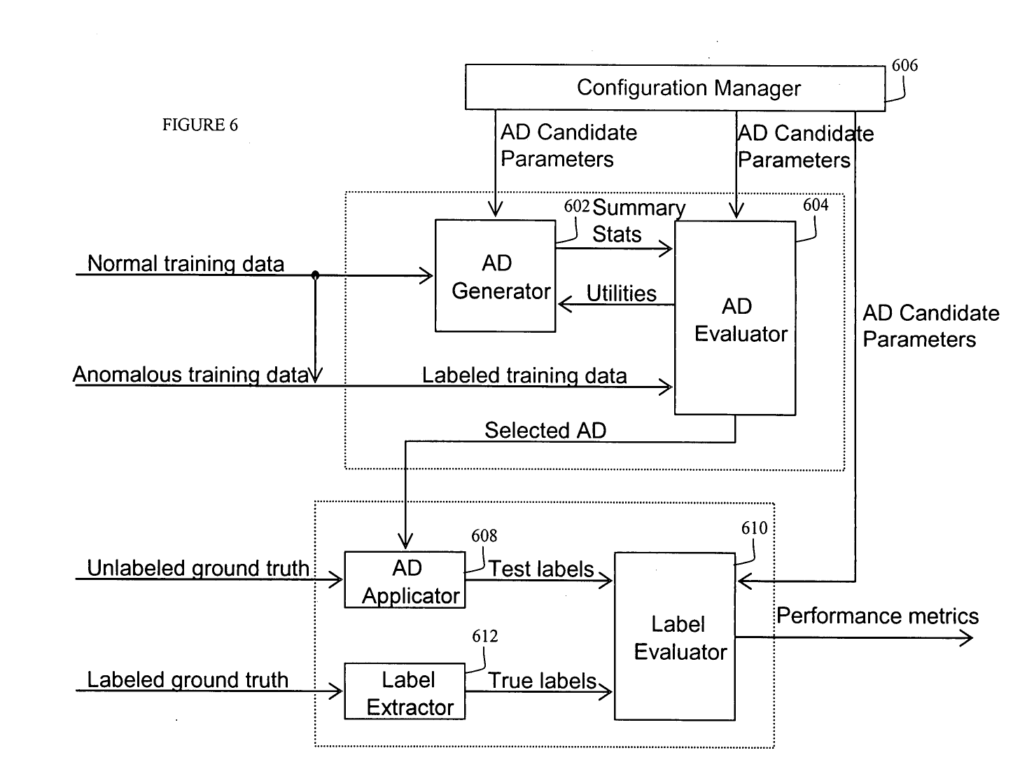

FIG. 6 shows another block diagram illustrating the present teachings using a system in which “normal” training data and “anomalous” training data can be provided to a system/method according to the present teachings, where the “normal” and “anomalous” training data can be established based on the embodiment and specifications from a user/operator. As indicated by FIG. 6, the normal data can be provided to an AD Generator 602 for generation of summary statistics based on the normal data, while the summary statistics can be provided to an AD Evaluator 604 with normal and anomalous data, and data from a Configuration Manager 606 (e.g., user interface or other manual and/or automated mechanism for selecting and/or providing AD candidate system attribute, attribute parameters, etc.), where the illustrated AD Evaluator 604 allows for evaluation of the candidate ADs (e.g., computation of “Utilities” such as probability of false positives, probability of false negatives, utility metric, etc.) for different ADs. As FIG. 6 indicates, the “Utilities” computed by the illustrated AD Evaluator 604, subject to search criterion (e.g., FIG. 2, 210) can be provided back to the illustrated AD Generator 602 with parameters from the illustrated Configuration Manager 606 to allow for a search for a new set of candidate ADs (e.g., through genetic/evolutionary techniques, etc., see also FIG. 2, 212).

As further indicated in FIG. 6, when the illustrated AD Evaluator 606 determines that a selected/identified AD candidate satisfies selected performance metrics/parameters, the selected/identified AD candidate's performance in labeling different data situations (e.g., normal, anomalous, etc.) can be tested against known labels and other performance parameters to provide performance metrics for the identified/selected AD. As shown in FIG. 6 and as previously demonstrated herein through FIG. 5, an AD Applicator 608 can apply unlabeled ground truth data to the selected AD candidate to allow for classification of such data as “normal” or “anomaly”, wherein such labels can be provided to the illustrated Label Evaluator 610 which also receives the “True Labels” from a Label Extractor 612 for the same data, thereby allowing for a computation of “Performance Metrics” of the selected AD candidate (e.g., utility metric). Although FIG. 6 provides one exemplary system, it can be understood that such example is provided for illustration and not limitation.

One of ordinary skill can thus understand that the present teachings may be extended to unsupervised learning and/or clustering embodiments that may allow for the maintenance of more than one normal state. Further, in some embodiments, interactions amongst cycles may be considered to support temporally ordered features. Automated embodiments may allow for a start of an AD candidate population with a single (e.g., relative “best”) system attribute or subset of system attributes, with an addition of a further system attribute(s) at further iterations. In embodiments, a superset of system attributes can be initially used with further iterations eliminating or removing one or more system attributes from the superset.

In some teachings, a sliding data window can allow for further system attribute and/or attribute parameter specifications for window size, stride, and cycle influence, while some embodiments may employ random sampling of data. Search spaces can be extended using trimmed means, medians, interquartile ranges, Chi-squared tests, and other schemes.

In an embodiment, a weighting scheme can be employed that can penalize AD candidates based on the number of system attributes, e.g., penalize AD candidates having less than a specified number/number range of system attributes, more than a specified number/number range of system attributes, etc. A constraint on the number of false positives and false negatives can be implemented, and/or a cost of false positives can be set to a multiple of the cost of false negatives.

As provided previously herein, other metrics can be used, such as probability of anomaly for each system attribute, determining the average number of cycles elapsed before detection of an attack, determining the number of false positives per attack, and/or determining a probability of detection per attack rather than on a per cycle basis. Other utility schemes can include geometric mean (“G-mean”), weighted precision, harmonic mean (“F-measure”), and others.

What has thus been described are methods, systems, and processor-readable media for selecting an anomaly detector for a system, including: generating an anomaly detector (AD) candidate population by characterizing AD candidates by one or more system attributes; training the AD candidate population using non-anomaly associated with the system and the system attribute(s); evaluating the AD candidate population based on applying non-anomaly and anomaly data associated with the system to the AD candidate population; and, based on at least one search criterion, performing at least one of (i) selecting an AD candidate from the AD population; and, (ii) modifying the AD candidate population and iteratively returning to training the AD candidate population.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor” and “a processor”, or “the microprocessor” and “the processor,” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices that can be similar or different devices. Use of such “microprocessor” or “processor” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet. References herein to microprocessor instructions or microprocessor-executable instructions, in accordance with the above, can be understood to include programmable hardware.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Accordingly, many additional changes in the details, materials, and arrangement of parts, herein described and illustrated, can be made by those skilled in the art, and it will be understood that the present teachings can include practices otherwise than specifically described.

What is claimed is:

1. A method for selecting an anomaly detector for a system, the method comprising:
generating an anomaly detector (AD) candidate population by characterizing AD candidates by at least one system attribute,
training the AD candidate population using non-anomaly data associated with the system and the at least one system attribute,
evaluating the AD candidate population based on applying non-anomaly and anomaly data associated with the system to the AD candidate population, and,
based on at least one search criterion, performing at least one of:
selecting an AD candidate from the AD population; and,
modifying the AD candidate population and iteratively returning to training the AD candidate population.

2. A method according to claim 1, where evaluating the AD candidate population includes determining at least one performance metric for the AD candidates in the AD candidate population.

3. A method according to claim 1, where the at least one performance metric includes a utility function based on at least one of: a probability of false positives and a probability of false negatives.

4. A method according to claim 1, where the at least one performance metric includes at least one of a Geometric mean, a Weighted Precision, and a Harmonic Mean scheme.

5. A method according to claim 1, where selecting an AD candidate includes:
comparing at least one performance metric associated with the AD candidates based on evaluating the AD candidate population; and,
identifying an AD candidate based on the comparison.

6. A method according to claim 1, where modifying the AD candidate population includes modifying based on evaluating the AD candidate population.

7. A method according to claim 1, where modifying the AD candidate population includes modifying the AD candidate population based on at least one genetic algorithm.

8. A method according to claim 1, where modifying the AD candidate population includes modifying based on sequential modification using a constraint associated with the at least one system attribute.

9. A method according to claim 1, where modifying the AD candidate population includes modifying the AD candidate population based on at least one unsupervised learning scheme.

10. A method according to claim 9, where the unsupervised learning scheme includes more than one normal state.

11. A method according to claim 1, where modifying the AD candidate population includes adding at least one system attribute to at least part of the AD candidate population.

12. A method according to claim 1, where modifying the AD candidate population includes eliminating at least one system attribute from at least part of the AD candidate population.

13. A method according to claim 1, where the at least one search criterion includes at least one of: a number of iterations, a time interval, and satisfaction of at least one performance criterion.

14. A method according to claim 1, where the at least one system attribute is associated with at least one attribute parameter, and training the AD candidate population includes processing data associated with the at least one system attribute based on the at least one associated attribute parameter.

15. A method according to claim 1, where the at least one system attribute is associated with at least one attribute parameter, where the at least one attribute parameter is associated with temporal alignment of data associated with at least one system attribute.

16. A method according to claim 1, where the at least one system attribute is associated with at least one attribute parameter, where the at least one attribute parameter is associated with mathematically transforming data associated with at least one system attribute.

17. A method according to claim 1, where the at least one system attribute is associated with at least one attribute parameter, and where the at least one attribute parameter is associated with filtering data associated with at least one system attribute.

18. A method according to claim 1, where the at least one system attribute is associated with at least one attribute parameter, where the at least one attribute parameter is associated with at least one of: partitioning data associated with at least one system attribute, and quantizing data associated with at least one system attribute.

19. A method according to claim 1, where evaluating the AD candidate population includes penalizing an AD candidate based on the number of system attributes associated therewith.

20. A method according to claim 1, where training the AD candidate population includes determining at least one summary statistic for each system attribute, where the at least one summary statistic is associated with a distance metric for determining an anomaly state.

21. A method according to claim 1, where evaluating the AD candidate population includes using at least one summary statistic obtained from training the AD candidate population to determine a probability of anomaly for the at least one system attribute, where the at least one summary statistic is associated with a distance metric for determining an anomaly state.

22. A method according to claim 1, where evaluating the AD candidate population includes, for a specified AD candidate and a specified time period, computing an overall probability of anomaly based on combining a probability of anomaly for each system attribute.

23. A method according to claim 22, where combining a probability of anomaly for each system attribute is based on a distance metric for determining an anomaly state.

24. A method according to claim 1, where evaluating the AD candidate population includes, for a specified AD candidate and a specified time period, comparing a probability of anomaly to a probability threshold.

25. A processor-readable medium having processor instructions embodied thereon, the processor instructions including instructions for causing a processor to:
generate an anomaly detector (AD) candidate population by characterizing AD candidates by at least one system attribute,
train the AD candidate population using non-anomaly data associated with system and the at least one system attribute,
evaluate the AD candidate population based on applying non-anomaly and anomaly data associated with the system to the AD candidate population, and,
based on at least one search criterion, perform at least one of:
select an AD candidate from the AD population; and,
modify the AD candidate population and iteratively return to train the AD candidate population.

26. A processor readable medium according to claim 25, where the processor instructions to evaluate the AD candidate population include instructions to generate at least one performance metric for the AD candidates in the AD candidate population.

27. A processor readable medium according to claim 26, where the at least one performance metric includes a utility function based on at least one of: a probability of false positives and a probability of false negatives.

28. A processor readable medium according to claim 26, where the at least one performance metric includes at least one of a Geometric mean, a Weighted Precision, and a Harmonic Mean scheme.

29. A processor readable medium according to claim 25, where the processor instructions to select an AD candidate include instructions to:
compare at least one performance metric associated with the AD candidates based on the evaluation of the AD candidate population; and,
identify an AD candidate based on the comparison.

30. A processor readable medium according to claim 25, where the processor instructions to modify the AD candidate population include instructions to modify based on evaluating the AD candidate population.

31. A processor readable medium according to claim 25, where the processor instructions to modify the AD candidate population include instructions to modify the AD candidate population based on at least one genetic algorithm.

32. A processor readable medium according to claim 25, where the processor instructions to modify the AD candidate population include instructions to modify based on sequential modification using a constraint associated with at least one system attribute.

33. A processor readable medium according to claim 25, where the processor instructions to modify the AD candidate population include instructions to modify the AD candidate population based on at least one unsupervised learning scheme.

34. A processor readable medium according to claim 33, where the unsupervised learning scheme includes more than one normal state.

35. A processor readable medium according to claim 25, where the processor instructions to modify the AD candidate population include instructions to add at least one system attribute to at least part of the AD candidate population.

36. A processor readable medium according to claim 25, where the processor instructions to modify the AD candidate population include instructions to eliminate at least one system attribute from at least part of the AD candidate population.

37. A processor readable medium according to claim 25, where the at least one search criterion includes at least one of: a number of iterations, a time interval, and satisfaction of at least one performance criterion.

38. A processor readable medium according to claim 25, where the at least one system attribute is associated with at least one attribute parameter, and the instructions to train the AD candidate population include instructions to process data associated with at least one system attribute based on the at least one associated attribute parameter.

39. A processor readable medium according to claim 25, where the at least one system attribute is associated with at least one attribute parameter, where the at least one attribute parameter is associated with a temporal alignment of data associated with at least one system attribute.

40. A processor readable medium according to claim 25, where the at least one system attribute is associated with at least one attribute parameter, where the at least one attribute parameter is associated with mathematically transforming data associated with at least one system attribute.

41. A processor readable medium according to claim 25, where the at least one system attribute is associated with at least one attribute parameter, where the at least one attribute parameter is associated with filtering attribute data associated with at least one system attribute.

42. A processor readable medium according to claim 25, where the at least one system attribute is associated with at least one attribute parameter, where the at least one attribute parameter is associated with at least one of: partitioning data associated with at least one system attribute, and quantizing data associated with at least one system attribute.

43. A processor readable medium according to claim 25, where the processor instructions to evaluate the AD candidate population include instructions to penalize an AD candidate based on the number of system attributes associated therewith.

44. A processor readable medium according to claim 25, where the processor instructions to train the AD candidate population include instructions to determine at least one summary statistic for each system attribute, where the at least one summary statistic is associated with a distance metric for determining an anomaly state.

45. A processor readable medium according to claim 25, where the processor instructions to evaluate the AD candidate population include instructions to use at least one summary statistic obtained from training the AD candidate population to determine a probability of anomaly for the at least one system attribute, where the at least one summary statistic is associated with a distance metric for determining an anomaly state.

46. A processor readable medium according to claim 25, where the processor instructions to evaluate the AD candidate population include instructions to, for a specified AD candidate and a specified time period, compute an overall probability of anomaly based on combining a probability of anomaly for each system attribute.

47. A processor readable medium according to claim 46, where the processor instructions to combine a probability of anomaly for each system attribute include instructions to combine based on a distance metric for determining an anomaly state.

48. A processor readable medium according to claim 25, where the processor instructions to evaluate the AD candidate population include instructions to, for a specified AD candidate and a specified time period, compare a probability of anomaly to a probability threshold.
